(19) United States
(12) Patent Application Publication
(10) Pub. No.: US 2015/0074436 A1
(43) Pub. Date: Mar. 12, 2015

(54) In-Kernel CPU Clock Boosting on Input Event

(71) Applicant: NVIDIA Corporation, Santa Clara, CA (US)

(72) Inventors: Vikas Ashok Jain, Pune (IN); Yogish Kulkarni, Pune (IN); Li Li, Cupertino, CA (US); Sunny Satish Shah, Pune (IN)

(73) Assignee: NVIDIA Corporation, Santa Clara, CA (US)

(21) Appl. No.: 14/023,241

(22) Filed: Sep. 10, 2013

(51) Int. Cl. G06F 1/32; G06F 1/26

(52) U.S. Cl. CPC G06F 1/324; G06F 1/26
USPC 713/322; 713/300

(57) ABSTRACT

One embodiment provides a method to wake an electronic device having a central processing unit (CPU) from an idle condition. The method includes creating a worker queue in an interrupt-request (IRQ) driver module of the operating-system kernel of the device, receiving in the kernel an indication of user input in a form of an IRQ, and in response to receiving the indication of user input, posting a request in the worker queue to boost clock speed in the CPU. The request is then processed, causing an increase in the clock speed.

### BACKGROUND

A central processing unit (CPU) of an electronic device may operate according to a power-management (PM) strategy. The PM strategy may be configured to limit overall power consumption in the device while also ensuring responsiveness to user input. One way to limit power consumption is to detect an idle condition—i.e., a condition where no computational work is necessary and no user input is being received—and to reduce the CPU clock speed during the idle condition. In some examples, the CPU clock speed may be reduced by a factor of 10 to 100. In this state, the CPU can still process certain background tasks, such as polling the input hardware for user input. However, the power dissipation within the CPU will be greatly reduced because of the lower clock speed, which is especially important if the electronic device is battery powered.

If, during the idle condition, the polling of the input hardware should reveal that a user input has been received—e.g., if the user depresses a key switch on the device or touches a touch-enabled display screen—then various actions may be required of the CPU. Depending on the nature of the user input, the CPU may be required to exit the idle condition by increasing the clock speed to its normal operational speed. Depending on the nature of the electronic device, various other actions may be required besides increasing the clock speed—powering up a display screen, communications system, or mass-storage device, for example. Naturally, one measure of the responsiveness of the electronic device is the latency associated with such tasks.

Currently, two state-of-the-art methods are used to boost the CPU clock speed in an idle electronic device on receipt of an indication of user input—typically an interrupt request (IRQ). One method is to boost the CPU clock speed in so-called user space—i.e., starting from the point where a user-event reader receives process control. However, this method provides an incomplete solution to the problem, as many processing steps may be required from receipt of the IRQ to execution of the user-event reader. When these steps are enacted at reduced clock speed, the resulting latency can be significant. Another method is to incorporate, within the kernel driver of the device, functionality that continuously receives raw data from the input hardware and parses the data for an indication of user activity. When such activity is detected, the CPU clock rate is boosted directly from the kernel—i.e., before execution is passed to the user-event reader. One disadvantage of this approach is that it requires a dedicated kernel process to remain active in the idle state, listening for user-input events in the raw data from the input hardware. Moreover, it too may exhibit significant latency, as the parsing of the raw data is enacted at reduced clock speed.

### BRIEF DESCRIPTION OF THE DRAWINGS

FIG. 1 shows a handheld, mobile electronic device in accordance with an embodiment of this disclosure.

FIG. 2 is a schematic, cutaway drawing showing aspects of an electronic device in accordance with an embodiment of this disclosure.

FIG. 3 illustrates a method to wake an electronic device from an idle condition in accordance with an embodiment of this disclosure.

### DETAILED DESCRIPTION

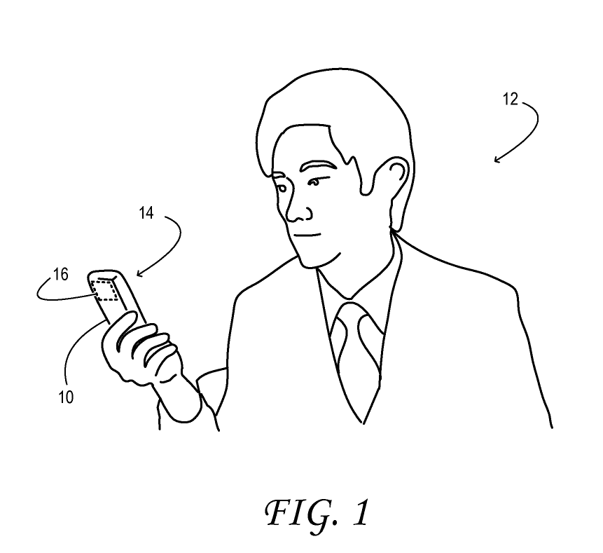

FIG. 1 shows an electronic device 10 being held in the hand of a user 12 and operated by the user. The user interacts with the device via display screen 14, which may in some examples be a touch screen. In the illustrated example, the electronic device is a handheld cellular telephone; in other examples, it may be handheld game system or personal digital assistant (PDA), or other portable, battery-powered device.

In the embodiment of FIG. 1, electronic device 10 is powered by a rechargeable battery 16. This device may be configured to execute a power-management (PM) strategy to reduce power consumption when the user is not actively using the device and when little or no computational activity is ongoing. In this manner, the periods between successive recharge events may be lengthened. Although PM strategies are especially important for mobile, battery-powered electronic devices, this aspect is by no means necessary, for PM strategies are also applicable to stationary, line-powered devices, to solar-powered devices, etc., where effective PM may reduce electricity costs and environmental impact and simplify cooling requirements.

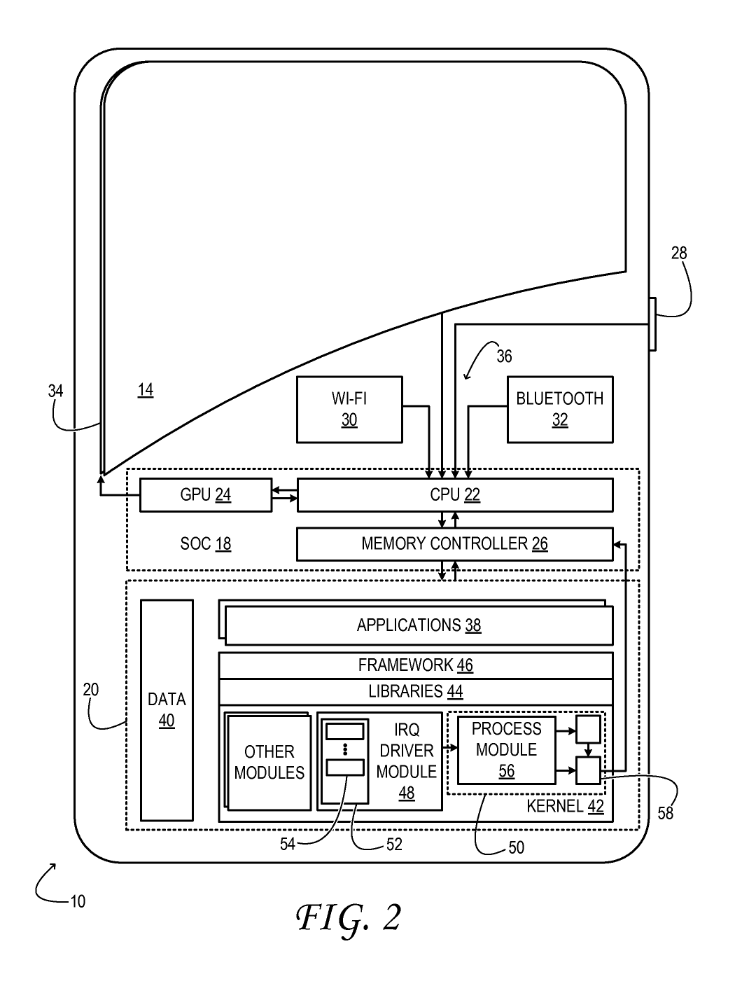

FIG. 2 shows additional aspects of electronic device 10 in schematic detail. In particular, the drawing shows a system-on-a-chip (SOC) 18 operatively coupled to a memory module 20 and to various other componentry. The SOC includes central-processing unit (CPU) 22 integrated together with graphics-processing unit (GPU) 24 and memory controller 26. The SOC may further include additional, integrated system components, such as a northbridge and southbridge.

In some embodiments, the CPU may be a multicore unit configured for simultaneous execution of a plurality of software threads. For example, the CPU may include two to four main processing cores with cache memory associated with each core, and in some cases shared between or among cores. In more particular embodiments, the CPU may include an additional low-power core to accomplish various background tasks with reduced power consumption.

In the embodiment of FIG. 2, SOC 18 is operatively coupled to certain input-output (10) componentry—to key switch 28, Wi-Fi radio 30, Bluetooth radio 32, touch-screen 14, and display component 34. In this and other embodiments, the SOC may be operatively coupled to additional componentry as well—to a cellular radio, camera, and/or global-positioning system (GPS) receiver, for example. To enable the display of text, graphics, and video on electronic device 10, display component 34 may include an active-matrix light-emitting diode (LED) display or liquid-crystal display (LCD) with a backlight. Such componentry may be arranged behind the touch-screen 14, which is transparent, to provide position and/or gesture sensitive touch recognition relevant to the image content displayed on the display component.

In the illustrated embodiment, activity from the various 10 componentry of electronic device 10 is signaled via an array of interrupt requests (IRQs) 36 to CPU 22. In this manner, the input hardware intended to wake electronic device 10 from an idle condition may be configured to assert in the CPU an IRQ indicative of user input. In one embodiment, such hardware may include a touch-screen display, which may assert an IRQ to indicate user touch—e.g., any touch, touch conforming to a predetermined set of conditions, or touch received in a predetermined region of the touch screen. In another embodiment, the input hardware may include a networking component (e.g., Wi-Fi radio 30, Bluetooth radio 32, or a cellular radio); such hardware may assert an IRQ to indicate receipt of a packet—e.g., any packet, a packet of a particular kind, etc. In yet another embodiment, the input hardware may be a key switch of the electronic device—e.g., an ON/OFF push button. The key switch may assert an IRQ to indicate key depression by a user of the electronic device—any depression, depression for more than a predetermined period of time, etc.

Continuing in FIG. 2, memory module 20 is configured to store various software and firmware aspects of electronic device 10 for execution in SOC 18. Physically, the memory module consists of an array of machine-readable, electronic memory components, which may include volatile memory, non-volatile memory, random-access memory (RAM), and read-only memory (ROM), for example. Such memory is accessed by the SOC componentry via integrated memory controller 26. The physical memory of the memory module may be partitioned logically into various sub-modules that instantiate the operating system (OS) of the electronic device, one or more applications 38, and various data structures 40.

In the embodiment of FIG. 2, the OS instantiated in memory module 20 includes a kernel 42, which runs on CPU 22. The kernel commands the various operations of SOC 18 at a low level. Running on top of the OS kernel are one or more libraries 44, which in turn support application framework 46. Example libraries may include a surface-manager library, a media framework library, a web-kit library, a structured query language (SQL) library, a secure shell (SSL) library, and/or a C-language library. The application framework is configured to support the various end-use applications of electronic device 10, such as browsers, games, navigation or telephony applications. To this end, the application framework may include a window manager, an activity manager, a resource manager, a notification manager and/or a location manager, for example. In some embodiments, the kernel may also support a core run-time library and/or virtual machine. Accordingly, the OS instantiated in memory module 20 may, in one non-limiting embodiment, be an Android® operating system.

In one embodiment, kernel 42 may be a Linux® kernel. It may include various hardware driver modules: a display driver, a camera driver, a Bluetooth driver, a flash-memory driver, a binder driver, a universal serial bus (USB) driver, a keypad driver, a Wi-Fi driver, and one or more audio drivers, for example. In the embodiment shown in FIG. 2, the kernel also includes interrupt-request (IRQ) driver module 48 and PM module 50. Formed within the IRQ driver module is a worker queue 52 configured to accommodate the posting of one or more requests, which may include a request 54 to boost the CPU clock speed. The kernel may post such a request in response to the receipt, at CPU 22, of an IRQ indicative of user activity—e.g., any user activity or activity of a particular kind and received from a predetermined subset of the IO hardware.

Continuing in FIG. 2, PM module 50 of kernel 42 includes a PM process module 56 and one or more PM quality-of-service (PM-QoS) helper functions 58. The PM process module may be configured to receive from kernel 42 a value representing the desired CPU clock speed, and to change the CPU clock speed based on the value. In general, the value received in the PM process module may be Boolean or numeric. An example of a Boolean value may include a value of ‘true’, to indicate that the clock speed should be raised to its normal operating speed. Examples of numeric value may include an absolute value of ‘500’, to indicate that the clock speed should be raised to a value of 500 megahertz, or ‘+400’ to indicate that the clock speed should be raised by 400 megahertz from its current value. In some embodiments, PM_QoS helper functions 58 may be invoked by PM process module 56 in order to raise the clock speed. Thus, through the activity of the PM process module, CPU 22 may be configured to process the request to boost the CPU clock speed. In this manner, electronic device 10 may be configured to wake with reduced latency from an idle condition.

In contrast to certain prior solutions, the boosting of the CPU clock speed in the present approach is enacted directly from the OS kernel of the electronic device. Thus, the boosting can occur promptly, without having to wait for the IRQ to filter up to a user-event reader. Nevertheless, the overall device-waking approach remains IRQ-based, and does not require the CPU to continuously parse raw data from the input componentry simply to detect user action. When implemented on a modern, multicore device that supports a 600 megahertz clock rate, this approach has reduced the latency of response to a touch-screen event from an initial range of 60 to 100 milliseconds down to a range of 20 to 25 milliseconds.

No aspect of the drawings should be interpreted in a limiting sense, for numerous other configurations lay fully within the spirit and scope of this disclosure. For example, while FIG. 2 shows CPU 22 integrated into SOC 18, this aspect is by no means necessary. The disclosed approach is equally applicable in traditional, stand-alone CPUs capable of slower clocking for reduced power consumption. Moreover, this approach does not rely on the various networking componentry of FIG. 2 to be included in the electronic device. Even where such componentry is included, it need not be configured to wake the electronic device from an idle condition in each and every embodiment.

The configurations described above enable various methods to wake an electronic device from an idle condition. Accordingly, some such methods are now described, by way of example, with continued reference to the above configurations. It will be understood, however, that the methods here described, and others within the scope of this disclosure, may be enabled by different configurations as well. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

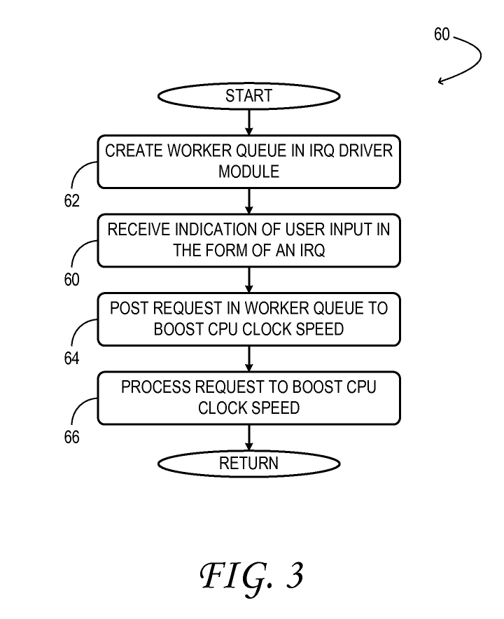

FIG. 3 illustrates an example method 60 to wake an electronic device from an idle condition. The method may be enacted in an electronic device as described above; it may result in the CPU clock speed being boosted less than 50 milliseconds after receipt of the IRQ indicative of user input.

At 62 of method 60, a worker queue is created in an interrupt-request (IRQ) driver module of an OS kernel of the electronic device. At 60 an indication of user input in the form of an IRQ is received in the kernel. Then, in response to receiving the indication of user input, at 64 a request to boost the CPU clock speed is posted in the worker queue. At 66, the request to boost the CPU clock speed is processed, which results in the desired increase in CPU clock speed. The range of increase of the CPU clock speed may differ in the different embodiments of this disclosure. In one example, the CPU clock speed may be less than 100 megahertz during the idle condition and may be boosted to more than 600 megahertz after processing the request. Naturally, the request to boost the CPU clock speed may be one of a plurality of requests posted to the worker queue and subsequently processed. The plurality of requests may further include activation of a display component of the electronic device, for example.

In one embodiment, processing the request to boost the CPU clock speed may include passing a value representing the desired CPU clock speed to a process module configured to change the CPU clock speed. More particularly, processing the request to boost the CPU clock speed may include invoking a PM_QoS helper function residing in a PM module of the kernel.

It will be noted that the method steps detailed herein are non-limiting in nature. In some embodiments, such steps may be used in conjunction with other methods. For example, method 60 may be used as part of an overall PM scheme that also detects an idle condition of the electronic device and lowers the CPU clock speed upon detection of the idle condition—e.g., at a predetermined period of time following detection of the idle condition.

It will be noted that the drawing figures included in this disclosure are schematic and generally not drawn to scale. Rather, the various drawing scales, aspect ratios, and numbers of components shown in the figures may be purposely distorted to make certain features or relationships easier to see. It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

1. Enacted in an electronic device having a central processing unit (CPU) and an operating-system kernel, a method to wake the electronic device from an idle condition, the method comprising:
creating a worker queue in an interrupt-request (IRQ) driver module of the kernel;
receiving in the kernel an indication of user input in a form of an IRQ;
in response to receiving the indication of user input, posting a request in the worker queue to boost clock speed in the CPU; and
processing the request to boost the clock speed.

2. The method of claim 1 wherein processing the request to boost the CPU clock speed includes passing a value representing a desired CPU clock speed to a process module configured to change the CPU clock speed.

3. The method of claim 1 wherein processing the request to boost the CPU clock speed includes invoking a power-management quality-of-service (PM_QoS) helper function.

4. The method of claim 1 wherein the electronic device is a battery-powered electronic device.

5. The method of claim 1 wherein the request to boost the CPU clock speed is one of a plurality of requests posted to the worker queue and subsequently processed.

6. The method of claim 5 wherein the plurality of requests further includes activation of a display component of the electronic device.

7. The method of claim 1 further comprising:
detecting an idle condition of the electronic device; and
lowering the CPU clock speed in response to detection of the idle condition.

8. The method of claim 1 wherein the CPU clock speed is less than 100 megahertz during the idle condition and is boosted to more than 600 megahertz after processing the request to boost the CPU clock speed.

9. The method of claim 1 wherein processing the request to boost the CPU clock speed results in the CPU clock speed being boosted less than 100 milliseconds after receipt of the IRQ at the CPU.

10. An electronic device configured to wake with reduced latency from an idle condition, the device comprising:
a central processing unit (CPU) with machine-readable memory operatively coupled to one or more processors;
input hardware configured to assert in the CPU an interrupt-request (IRQ) indicative of user input;
an operating system kernel running on the CPU, the kernel including an IRQ driver module and a worker queue formed within the IRQ driver module, the kernel configured to post in the worker queue a request to boost clock speed in the CPU in response to receiving the IRQ, the kernel being further configured to process the request to boost the clock speed.

11. The electronic device of claim 10 wherein the input hardware is a touch-screen display, and wherein the IRQ indicates user touch on the touch-screen display.

12. The electronic device of claim 10 wherein the input hardware is a networking component, and wherein the IRQ indicates receipt of a packet from the networking component.

13. The electronic device of claim 10 wherein the input hardware is a key switch of the electronic device, and wherein the IRQ indicates depression of the key switch by a user of the electronic device.

14. The electronic device of claim 10 wherein the CPU is integrated together with a graphics processing unit and memory manager in a system-on-a-chip.

15. The electronic device of claim 10 further comprising:
one or more application libraries arranged over the kernel;
an application framework arranged over the one or more libraries; and
one or more applications running on the application framework.

16. The electronic device of claim 10 further comprising a power-management process module instantiated within the kernel, wherein the power-management (PM) process module is configured to receive a value representing a desired CPU clock speed, and to change the CPU clock speed based on the value.

17. The electronic device of claim 16 wherein the PM process module is configured to change the CPU clock speed by invoking one or more PM quality-of-service (PM-QoS) helper functions residing in the kernel.

18. A system-on-a-chip (SOC) configured to wake with reduced latency from an idle condition, the SOC comprising:
a central processing unit (CPU) configured to receive an interrupt request (IRQ) from external input hardware in an electronic device, the IRQ indicative of user input;
a memory controller operatively coupled to machine-readable memory, the memory holding instructions to instantiate an operating system kernel to run on the CPU, the kernel including an IRQ driver module and a worker queue formed within the IRQ driver module, the kernel configured to post in the worker queue a request to boost clock speed in the CPU in response to receiving the IRQ; and
a processing module configured to process the request to boost in the clock speed.

19. The SOC of claim 18 wherein the input hardware is a touch-screen display, and wherein the IRQ indicates user touch on the touch-screen display.

20. The SOC of claim 18 wherein the input hardware is a networking component, and wherein the IRQ indicates receipt of a packet from the networking component.
